(19) United States
(12) Patent Application Publication
(10) Pub. No.: US 2026/0048761 A1
(43) Pub. Date: Feb. 19, 2026

(54) METHOD FOR MODIFYING OPERATING BEHAVIORS OF AN AUTONOMOUS VEHICLE TO SAFELY NAVIGATE ADVERSE ROAD CONDITIONS

(71) Applicant: Torc Robotics, Inc., Blacksburg, VA (US)

(72) Inventors: Carlo Elwinger, Maulbronn (DE); Simon Schäfer, Stuttgart (DE); Janine Guenther, Leinfelden (DE)

(21) Appl. No.: 18/805,259

(22) Filed: Aug. 14, 2024

(51) Int. Cl. B60W 60/00; B60W 10/06; B60W 10/10; B60W 10/18; B60W 10/20; B60W 30/14

(52) U.S. Cl. CPC B60W 60/001; B60W 10/10; B60W 30/143; B60W 30/146; B60W 10/06; B60W 10/18; B60W 10/20; B60W 2555/20

(57) ABSTRACT

A method for operation of an autonomous vehicle in adverse weather conditions is provided. The method including detecting a first data indicative of at least one environmental conditions using one or more sensors and transmitting the first data of the at least one environmental conditions to a computing system controlling an operation of the autonomous vehicle. The method also comprises determining a confidence interval of each of the at least one environmental conditions based on the first data from the one or more sensors. Then based on the confidence interval, determining one or more behavior changes to the operation of the autonomous vehicle. The method further comprises implementing the one or more behavior changes to the operation of the autonomous vehicle.

### TECHNICAL FIELD

The field of the disclosure relates to methods for operating autonomous vehicles when traveling in adverse weather and road conditions, and in particular, to methods of operating autonomous vehicles when following autonomous, semi-autonomous, or non-autonomous lead vehicles and modify autonomous vehicle operating behaviors to safely follow lead vehicles and navigate adverse road conditions.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This comprises steering, braking and acceleration.

Autonomous vehicles share the road with other autonomous, semi-autonomous, and non-autonomous vehicles, and are expected to adhere to safety standards when driving, such as following the speed limit and maintaining a safe following distance from lead vehicles. However, when navigating roadways during adverse weather conditions, for example, freezing rain, sleet or snow, and on roads with physical characteristic which are more prone to accidents, winding curves or step gradients, the autonomous vehicle's driving behaviors need to be adjusted to safely navigate the roads in weather conditions that create dangerous road conditions. Further, to navigate the roads safely, the autonomous vehicle has to avoid road hazards that are a byproduct of the adverse weather conditions, for example, ice or water pools on the roadway. This may require driving the vehicle along the shoulder of the road or following tracks formed by other vehicles in snow-covered roads. Combinations of adverse weather conditions, road characteristics, and hazards, make the effective control of the behaviors of an autonomous vehicle difficult. For example, when driving along an icy uphill slope, there is a greater chance of traction loss since icy surfaces significantly reduce traction between the tire and the road. The reduced traction may cause the vehicle to get stuck or slide backwards. Further, the reduced traction on ice increases the risk of losing greater control of the vehicle. In such a situation, sudden acceleration or steering maneuvers can result in the vehicle skidding or sliding, making it challenging to maintain a stable path on the roadway. When a vehicle is not fully autonomous, and driven by a human driver, the human driver adjusts their driving behavior instinctively, to align with the road conditions, to safely control the vehicle. The change in driving behavior may, for example, comprise reducing vehicle speed, or maintaining a greater distance between the driver's vehicle and other vehicles on the road proximate the vehicle. The adverse driving conditions increase the human driver's level of alertness, making the driver ready to adapt to changes in the environment, roadway conditions, and the behavior of nearby vehicles. Autonomous vehicles are designed to operate in a specific Operation Design Domain (ODD), a domain or operating environment that the vehicle will typically experience on the roadways. Thus the ODD will likely not include extreme weather conditions not typically experienced by the autonomous vehicle when in use.

Accordingly, there exists a need for a system and method for dynamically modifying an autonomous vehicle's operating behaviors to align with changes in road conditions, so that the autonomous vehicle can safely navigate the roads. This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, a method for operation of an autonomous vehicle in adverse weather conditions is provided. The method comprises detecting a first data set indicative of at least one environmental conditions using one or more sensors and transmitting the first set of data of the at least one environmental conditions to a computing system for controlling operation of the autonomous vehicle. The method also comprises determining a confidence interval of each of the at least one environmental conditions based on the first set of data from the one or more sensors. Then, based on the confidence interval, determining one or more behavior changes to the operation of the autonomous vehicle. The method further comprises implementing the one or more behavior changes in the operation of the autonomous vehicle.

In another aspect, a method for operation of an autonomous vehicle in adverse weather conditions is provided. The method comprises transmitting a first data set indicative of at least one environmental condition to a computing system that controls operation of the autonomous vehicle, and transmitting a second data set indicative of the at least one environmental condition received from at least one third party to the computing system. The method also comprises determining a confidence interval of each of the at least one environmental conditions based on the first data set and the second data set and then determining one or more behavior changes to the operation of the autonomous vehicle based on the confidence interval. Lastly, the method comprises modifying the one or more behavior changes of the autonomous vehicle to align with the environmental conditions represented by the first and second data sets.

In yet another aspect, a method for operation of a fleet of autonomous vehicles in adverse weather conditions is provided. The method comprises detecting an ambient environmental condition of each autonomous vehicle in the fleet of autonomous vehicles and storing the ambient environmental condition of each autonomous vehicle in a database. The method also comprises transmitting the ambient environmental condition of at least one other autonomous vehicle to a first computing system for controlling an operation of a first autonomous vehicle in the fleet of autonomous vehicles and determining a first confidence interval of the ambient environmental condition of the first autonomous vehicle based on the ambient environmental condition of the at least one other autonomous vehicle. Then, based on the confidence interval, the method determines one or more first behavior changes to be made to the operation of the first autonomous vehicle based on the confidence interval, and implements the one or more behavior changes to the operation of the first autonomous vehicle.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of an autonomous truck;

FIG. 2 is a block diagram of the autonomous truck shown in FIG. 1;

FIG. 3 is a block diagram of an example computing system;

FIG. 4 is a diagram of an autonomous truck operating in adverse conditions;

FIG. 5 is a block diagram of an example computing system for implementing behavior changes in adverse conditions; and

FIG. 6 is a flow chart depicting a method of operation of an autonomous vehicle in adverse conditions.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations, such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations, such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

As described herein, methods for autonomous vehicle operation in adverse weather and road conditions are provided. Although the methods discussed herein are described in relation to autonomous vehicles, it is appreciated that the methods discussed may be applicable for use with semi-autonomous vehicles, for example an autonomy level 3 vehicle. The methods described herein generally operate in three stages, sensing, planning, and acting. First the autonomous vehicle senses the environment, determining the ambient weather and road conditions using sensors such as cameras, temperature sensors, and global positioning sensors (GPS), as well as information transmitted by other autonomous vehicles or mangers in the autonomous vehicle fleet and weather forecasts. Then, based on the perceived environmental conditions, the autonomous vehicle formulates planned actions and a trajectory of the autonomous vehicle to adapt the vehicle's behavior as desired. Finally, the autonomous vehicle sets the planned behavior changes and trajectory into action, actuating motion controls of the vehicle.

In some embodiments, the sensing of ambient environmental conditions comprises generating a confidence interval of a perceived condition based on data from various sensors and sources. Then, when determining the planned trajectory and behavior changes, the confidence interval of a particular ambient condition is compared against one or more threshold values to determine what behavior changes, if any, are desirable for a given environmental condition.

In some embodiments, the perceived ambient conditions are sent to a data report system for a fleet of autonomous vehicles and stored on a database for later use. The stored ambient conditions can then be used to influence the confidence interval of certain environmental conditions. For example, if multiple autonomous vehicles previously perceived a steep road gradient or icy conditions and reported those findings, when another autonomous vehicle detects similar conditions, the confidence interval may increase. This same information may be used to influence the threshold value of certain trajectories and behavior changes.

In some embodiments, the autonomous vehicle is equipped with specialized equipment for driving in particular environment which may be deployed as desired given the ambient conditions and planned behavior changes. For example, the autonomous vehicle may be equipped with automatic snow chains (sometimes referred to as automatic tire chains) which the autonomous vehicle may choose to deploy.

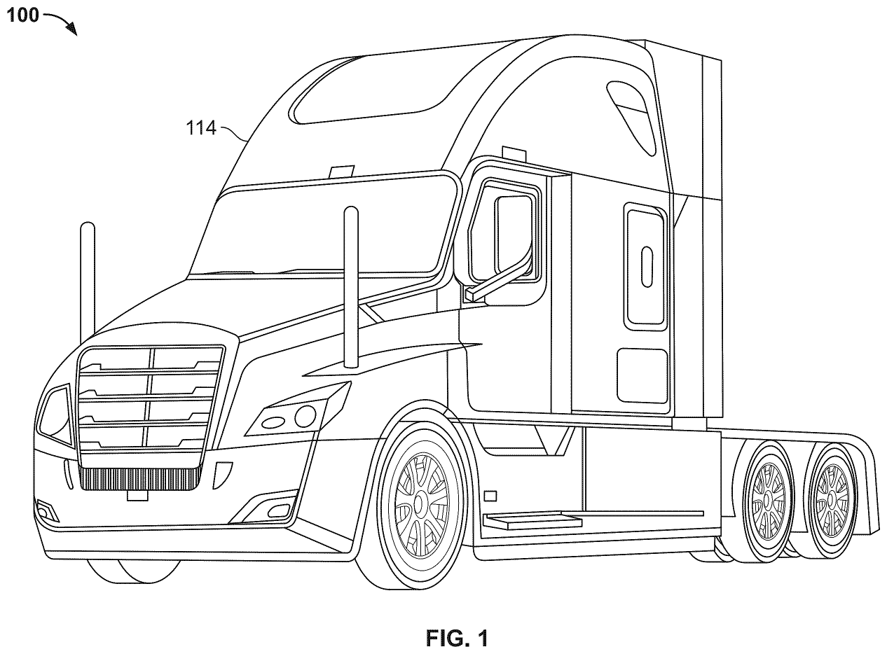

Various embodiments in the present disclosure are described with reference to FIGS. 1-6 below.

FIG. 1 illustrates a vehicle 100, such as a truck, that may be conventionally connected to a single or tandem trailer to transport the trailer (not shown) to a desired location. The vehicle 100 comprises a cabin 114 that can be supported by and steered in the required direction, by front wheels and rear wheels that are partially shown in FIG. 1. Front wheels are positioned by a steering system that comprises a steering wheel and a steering column (not shown in FIG. 1). The steering wheel and the steering column may be located in the interior of cabin 114.

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors.

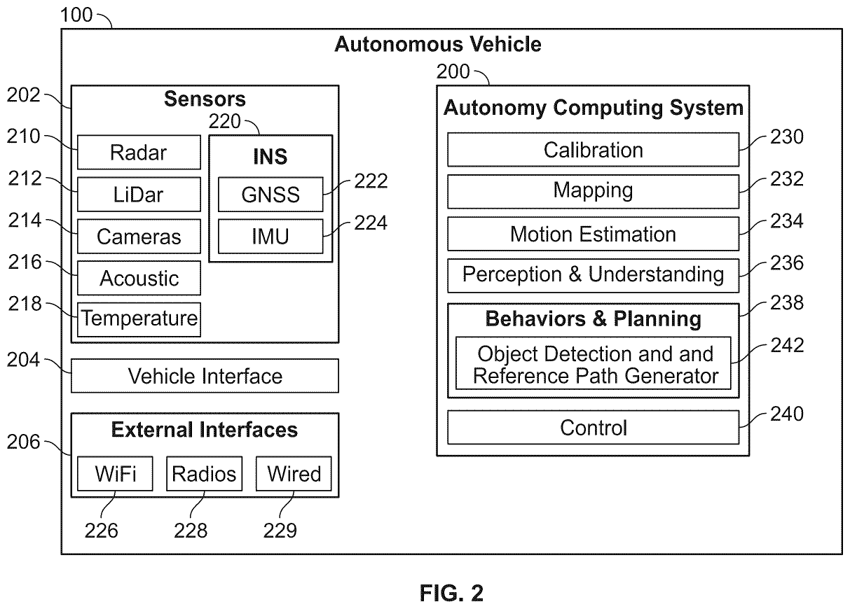

FIG. 2 is a block diagram of autonomous vehicle 100 shown in FIG. 1. In the example embodiment, autonomous vehicle 100 comprises autonomy computing system 200, sensors 202, a vehicle interface 204, and external interfaces 206.

In the exemplary embodiment, sensors 202 may include various sensors, such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 comprises multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying one or more construction markers (or nodes), generating one or more connectivity graphs based upon identified construction markers (or nodes), updating a reference path based upon the one or more connectivity graphs, transmitting the updated reference path to other modules of the autonomy computing system 200, or mission control, or both.

In some embodiments, the image data generated by cameras 214 may be transmitted to mission control for one or more of identifying one or more construction markers (or nodes), generating one or more connectivity graphs based upon identified construction markers (or nodes), updating a reference path based upon the one or more connectivity graphs, transmitting the updated reference path to the autonomy vehicle 100 for guiding autonomous vehicle 100 to drive on the updated reference path.

LiDAR sensors 212 generally include a laser generator and a detector that sends and receives a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation/attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222, and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226, other radios 228, or a wired connection 229. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206, or updated on demand. In some embodiments, autonomous vehicle 100 may deploy with all of the data it needs to complete a mission (e.g., perception, localization, and mission planning) and may not utilize a wireless connection or other connections while underway.

In the exemplary embodiment, autonomy computing system 200 is implemented by one or more processors and memory devices of autonomous vehicle 100. Autonomy computing system 200 comprises modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and an object detection and reference path generator module 242. The object detection and reference path generator module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The object detection and reference path generator module 242 may perform one or more tasks including, but not limited to, identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein, the term “autonomous” comprises both fully autonomous and semi-autonomous.

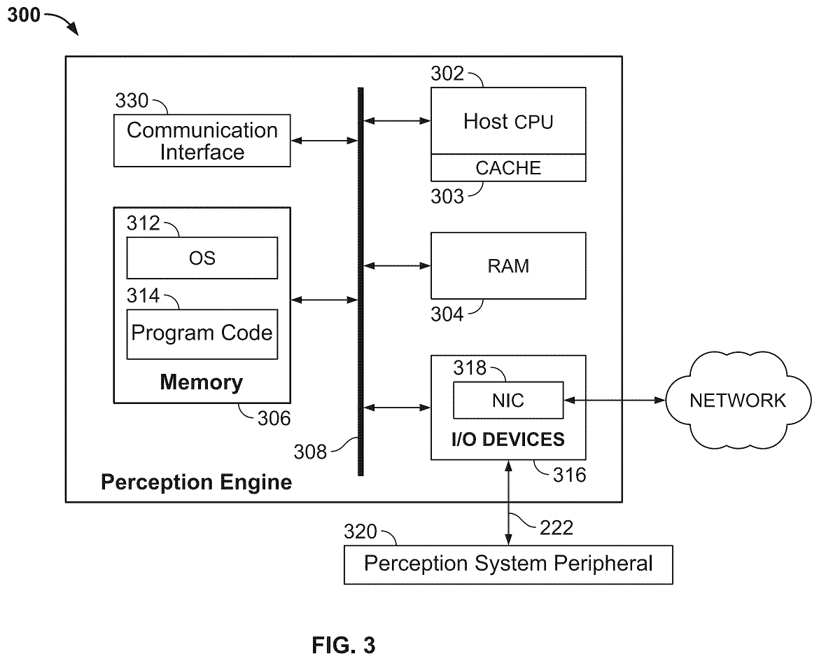

FIG. 3 is a block diagram of an example computing system 300, such as the autonomy computing system 200 shown in FIG. 2, configured for sensing an environment in which an autonomous vehicle is positioned. Computing system 300 comprises a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that comprises at least a memory section storing an OS 312 and a section storing program code 314. Program code 314 may be one of the modules in the autonomy computing system 200 shown in FIG. 2. In alternative embodiments, one or more section(s) of memory 306 may be omitted and the data stored remotely. For example, in certain embodiments, program code 314 may be stored remotely on a server or mass-storage device and made available over a network 332 to CPU 302.

Computing system 300 also comprises I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

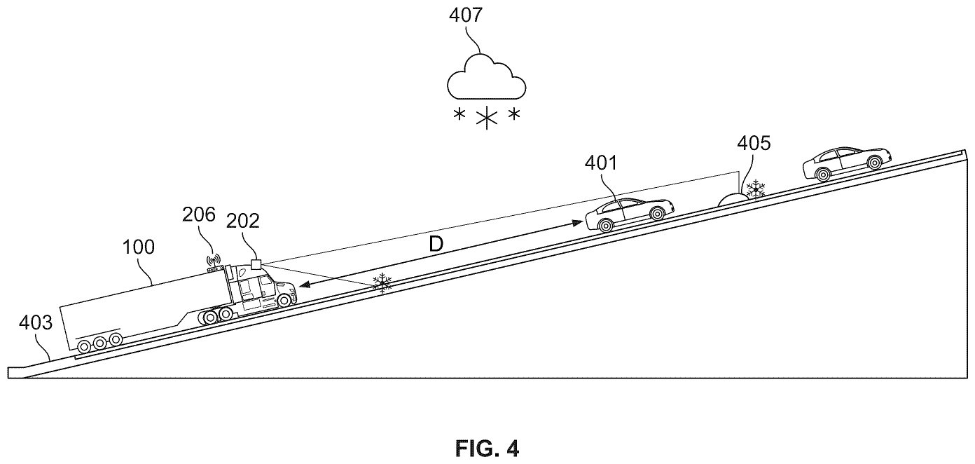

Referring now to FIG. 4, shown is the autonomous vehicle 100 operating in adverse weather and road conditions according to some embodiments of the present disclosure. During operation, an autonomous vehicle 100 will follow a lead vehicle 401, maintaining a following distance D. The lead vehicle 401 may be an autonomous or a non-autonomous vehicle. The distance D is generally defined as the distance the autonomous vehicle 100 needs to safely operate and react to changing conditions, i.e., to sense and react to changing environmental conditions. This distance D is defined by the autonomy computing system 200 and associated modules 234, 236 and 238 previously described herein. Subsequently, depending on the environmental conditions, for example, the characteristics of the road 403, hazards 405, such as an object in the road or bump on the road 403, or weather conditions 407, the autonomous vehicle 100, through the autonomy computing system 200 and associated modules, will adjust the autonomous vehicle's following distance D relative to lead vehicle 401 to achieve safe operation of the autonomous vehicle 100, consistent with the sensed environmental conditions through which the autonomous vehicle is being operated.

Characteristics of the road 403 can include the gradient/incline/decline of the road, the type of road surface, for example, asphalt, dirt, gravel, concrete, etc., the curvature of any turns along the road 403, or other physical properties of the road 403. In some embodiments, the characteristics of the road 403 are determined by a combination of the data from the sensors 202 and information from third parties, and the third parties may include for example, other vehicles, a fleet commander, the vehicle owner, regulatory or governmental agencies, such as the National Weather Service, Federal Highway Administration, or the National Highway Traffic Safety Administration, local government agencies, local weather agencies, or emergency services, transmitted to the external interfaces 206. For example, sensors 202, such as cameras 214, may be used to determine the type of road surface 403. In some embodiments, the gradient/incline/decline of the road 403 may be retrieved from a database of road gradient maps. The database may be included in the mapping module 232 of the autonomy system 200. In some embodiments, the database of road gradient maps, or other databases of road characteristics, is maintained by an autonomous vehicle fleet based on reported data from sensors 202 on individual autonomous vehicles 100 in the fleet.

Hazards 405 can include conditions on the road, for example, ice, water, or snow, and obstacles in the road, for example, pot holes or debris, or other obstructions or conditions which may impact the operational safety of the autonomous vehicle 100. In some embodiments, the lead vehicle 401 or other vehicles on the road may be classified as a hazard 405. In some embodiments, the hazards 405 are determined by a combination of the data from the sensors 202 and information from third parties transmitted to the external interfaces 206. For example, sensors 202, such as cameras 214, temperature sensors 216, or a weather radar, may be used to determine if there is ice on the road. In some embodiments local weather reports may be transmitted to the autonomous vehicle 100 via the external interfaces 206. In some embodiments, hazards 405 detected by another autonomous vehicle 100 in a fleet of autonomous vehicles may be transmitted from one autonomous vehicle to another or to a fleet commander or command center to be transmitted across the fleet. This may be used as a feedback confirmation loop, whereby multiple vehicles in the fleet will verify the hazard 405 resulting in greater confidence of the existence of a hazard 405.

For example, sensors on a first autonomous vehicle will detect the presence of ice formed on the road 403 and transmit that information to the fleet commander. Then, when a second autonomous vehicle drives on that same road at a later time, the fleet commander will transmit data communicating that there is ice formed on the road to the second, later-arriving autonomous vehicle. This communication methodology may also be applied to hazards 405 located on the road. Sensors on the second autonomous vehicle will detect that there is ice on the road and transmit that information to the fleet commander. The data transmitted by the second autonomous vehicle will confirm the presence of ice/snow on the road that was previously sensed by the first autonomous vehicle to operate along the same section of road. Confirming the presence of ice/snow will confirm the accuracy of the information collected previously. Additionally, the road conditions can then be communicated to autonomous vehicles that will later travel the same section of roadway after the second autonomous vehicle. Alternatively, if the second autonomous vehicle does not detect that there is ice on the road, this information will be transmitted to the fleet commander, decreasing confidence that there is ice on the road.

Weather conditions 407 can include rain, sleet, snow, fog, or other ambient weather conditions. In some embodiments, the weather conditions 407 are determined by a combination of the data from the sensors 202 and information from third parties transmitted to the external interfaces 206. Sensors 202, such as cameras 214, temperature sensors 216, or a weather radar, may be used to determine the ambient weather conditions 407. In some embodiments, local weather reports may be transmitted to autonomous vehicle 100 via the external interfaces 206. In some embodiments, weather conditions 407 detected by another autonomous vehicle 100 in a fleet of autonomous vehicles may be transmitted from one autonomous vehicle to another, or to a fleet commander or command center to be transmitted across the fleet.

In some embodiments, during operation, the autonomous vehicle 100 continuously, or at set intervals, receives information about the environmental conditions, e.g., the position of the lead vehicle 401, characteristics of the road 403, hazard positions 405, and/or weather conditions 407, from the sensors 202 or from third parties via the external interfaces 206. Based on the environmental conditions, the autonomous vehicle 100 implements identified vehicle behavior changes required to maintain safe operation of the autonomous vehicle 401 in light of the vehicle 401 position, road characteristics 403, hazards 405 and weather conditions 407. These behavior changes may include, but are not limited to, reducing the speed of the autonomous vehicle, maintaining momentum and avoiding abrupt acceleration or deceleration, avoiding sudden movements by implementing subtle steering adjustments, increasing the following distance to the lead vehicle 401 to provide more reaction time to behavior changes of the lead vehicle 401, utilizing features in the road, for example, pre-existing tire tracks, or shifting the autonomous vehicle into a lower gear.

In some embodiments, the behavior changes may also include deploying or activating accessories on the autonomous vehicle 100. For example, lowering a snow plow to clear a road, activating a dynamic tire pressure device to reduce pressure in the tires to increase traction, and deploying automatic snow chains, although not limited thereto.

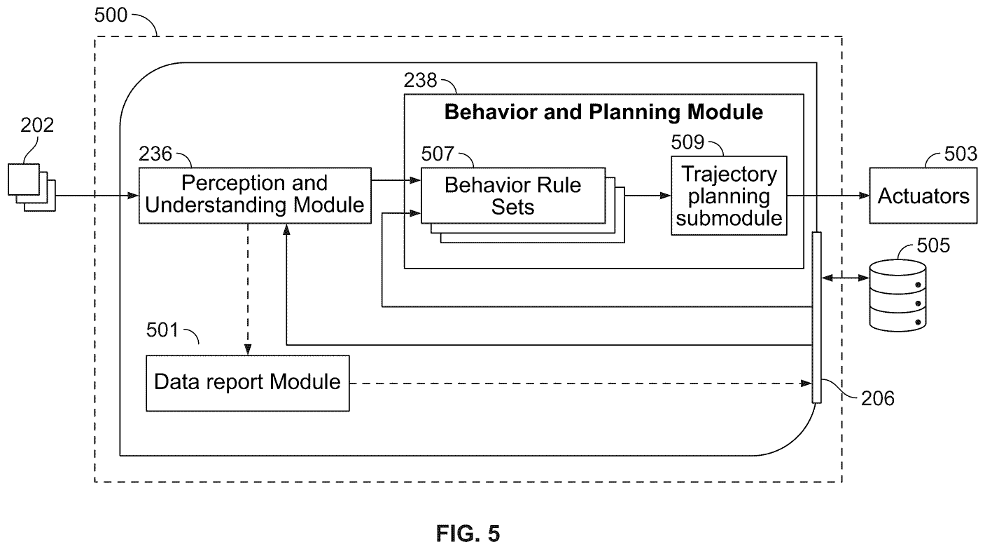

Referring now to FIG. 5, a computing system 500 is shown in FIG. 5 and the system is used for implementing behavior changes to the operation of an autonomous vehicle 100 operating in adverse conditions according to some embodiments of the present disclosure. The computing system 500 used to determine if vehicle operating behaviors should be modified may be a module of computing system 200 previously described. Alternatively, the computing system 500 may be used in combination with other modules of computing system 200 such as, for example, motion estimation module 234 and perception and understanding module 236. As shown in FIG. 5, in the exemplary embodiment, the behavior modifying computing system 500 comprises a perception and understanding module 236, a behavior and planning module 238, external interfaces 206, a data report module 501, and actuators 503.

The perception and understanding module 236 can receive information relating to environmental conditions from one or more of the sensors 202 and/or from a cloud storage 505. The cloud storage 505 may be any source of data external from the autonomous vehicle 100, including public online information from weather stations, government agencies, or map providers, and private information from a fleet commander, although not limited thereto. The sensors 202 may include a temperature sensor 218, a LiDAR 212, and cameras 214, although not limited thereto. The temperature sensor 218 may be used to measure the ambient temperature and the temperature of the road surface. The LiDAR 212 may be used to provide high-resolution 3D mapping of the road surface to detect surface irregularities and changes in texture and reflectivity of the road that might indicate the presence of water or ice. For example, ice may create a smoother, more reflective surface compared to dry asphalt. The cameras 214 may be used to detect changes in color and texture; for example, ice can give the road a glossy, shiny appearance, which is distinguishable from dry or wet surfaces. Image processing algorithms may be used to detect changes in the color, reflectivity, and texture of the road. The cameras 214 may also use pattern recognition, using machine learning models trained on images of icy, wet, and dry roads to classify the current road condition, applying convolutional neural networks (CNNs) to classify road conditions based on real-time camera footage.

In some embodiments, one or more autonomous vehicles 100 are in direct communication with each other sharing sensor data relating to the ambient weather conditions, the condition of the road, and other environmental conditions which can affect the operation of the autonomous vehicle 100. In some other embodiments, one or more autonomous vehicles 100 are in communication with a common computer network, for example, a fleet commander that receives sensor data from each autonomous vehicle 100 in the autonomous vehicle fleet and transmits the sensor data to the autonomous vehicle 100 in the fleet. The sensor data from the autonomous vehicle fleet is stored on the cloud storage 505 and is accessed by individual autonomous vehicles 100 as desired.

The perception and understanding module 236, having received the ambient environmental conditions from one or more of the sensors 202 and from the cloud storage 505, generates a confidence interval of the perceived environmental condition. In some embodiments, the confidence interval indicates the level of certainty or likelihood the behavior modifying computing system 500 has that a particular environmental condition is actually present based on the information from the sensors and/or third parties. In some embodiments, the confidence interval is determined by the perception and understanding module 236 based on information from at least two different sources. The sources may comprise a sensor or a third party, and may be from the same source at two different time intervals. For example, meteorological data from a local weather station at a first time and a second time may constitute the at least two sources relied on to generate the confidence interval.

For example, in some embodiments, a camera 214, e.g., a first source, may capture images of the road and transmit the images to the perception and understanding module 236, the images indicating the road is icy. The perception and understanding module 236 may also receive information from a weather station, e.g., a second source, indicating that freezing rain and icy conditions are present in the area where the autonomous vehicle is operating. Based on the sensor collected images and the information from the weather station, the perception and understanding module 236 may generate a high confidence interval that the road is icy. In some embodiments, the information received by the perception and understanding module 236 is weighted based on the source and reliability. For example, information from an local weather station may be weighted less than information from a fleet commander, and therefore will contribute less to the confidence interval generated by the perception and understanding module 236. In some embodiments, the confidence interval of the perceived environmental condition is sent to the data report module 501 and then exported for storage on the cloud storage 505 via the external interface 206.

Once the confidence interval for a given environmental condition is determined by the perception and understanding module 236, the confidence interval is transmitted to the behavior and planning module 238 to determine what behavior change, if any, should be implemented. The behavior and planning module 238 may include one or more behavior rule sets 507 defining different algorithms to implement behavior changes to the operation of the autonomous vehicle 100; for example, changing the velocity, the following distance to a lead vehicle, or the momentum of the autonomous vehicle 100.

In some embodiments, one of the behavior rule sets 507 may be a velocity of the autonomous vehicle 100 algorithm, a target distance to a lead vehicle algorithm, or a momentum of the autonomous vehicle algorithm.

For example, the velocity algorithm may be: velocity=base_velocity*(1−wet_velocity_reduction_factor*likelihood-iced_velocity_reduction_factor*likelihood-packed_snow_velocity_reduction_factor*likelihood-road_grade_velocity_reduction_factor*road_grade).

For example, the target distance to a lead vehicle algorithm may be: target_distance=base_distance*(1+wet_distance_factor*likelihood+iced_distance_factor*likelihood+packed_snow_distance_factor*likelihood+road_grade_distance_factor*road_grade).

For example, the momentum algorithm may be: momentum=base_momentum*(1−wet_momentum_reduction_factor*likelihood-iced_momentum_reduction_factor*likelihood-packed_snow_momentum_reduction_factor*likelihood-road_grade_momentum_reduction_factor*road_grade).

It is appreciated that these are exemplary non-limiting algorithms and that the behavior rule sets 507 may include other algorithms to affect the behavior of the autonomous vehicle 100 and that the algorithms may include more or fewer factors.

In the exemplary algorithms of the behavior rule sets 507, the velocity, target distance to a lead vehicle, and momentum are functions of the road condition, the likelihood of the road condition, the likelihood being the confidence interval of the given road condition, and the perceived road grade. In this way, the operating behavior, e.g., the velocity, target distance to a lead vehicle, and momentum of the autonomous vehicle 100, is determined by reducing/increasing the base operation for a given autonomous vehicle 100 based on certain environmental conditions and the likelihood or confidence that the environmental conditions are present.

In some embodiments, the base operating conditions and environmental factors may be determined based on characteristics of the autonomous vehicle 100; for example, whether the autonomous vehicle 100 is attached to trailer, the contents of the trailer, the weight of the autonomous vehicle 100, etc. In some embodiments, the base operating conditions and environmental factors may be manually inputted by a fleet commander, based on analytical data of the operation of the autonomous vehicle 100, based on regulatory requirements or suggestions, for example, speed limits or suggested following distances, or determined by a machine learning algorithm.

In some embodiments, the confidence interval or likelihood of a given environmental condition is continuously updated in real time as additional data is received from the sensors 202 or third parties. For example, a temperature sensor 218 may initially detect and transmit an ambient temperature of 0° C. (32° F.) to the perception and understanding module 236, which along with other sensor data results in a confidence interval that the road is iced. The temperature sensor 218 continues to detect the ambient temperature in real time and as the detected temperature increases, the confidence interval that the road is iced may decrease, resulting in a commensurate change based on the behavior rule sets 507. In some embodiments, the confidence interval or likelihood of a given environmental condition is expressed as a percentage or decimal.

In some embodiments, once the confidence interval of an environmental condition is determined, the confidence interval may be compared against one or more threshold values which may determine different actions or behavior changes to be implemented by the behavior and planning module 238 via the actuators 503. The actuators 503 may include devices that when powered or otherwise activated, control the steering, acceleration, deceleration, or other operating behavior, etc. of the autonomous vehicle 100, activating accessories on the autonomous vehicle 100, or otherwise implementing the behavior changes discussed herein. The threshold values may be associated with a specific environmental condition, for example, the temperature, the presence of ice on the road, road gradient/incline/decline, etc., may be associated with a combination of environmental conditions, or may be associated with a behavior change of the autonomous vehicle 100, for example the velocity, momentum, or target distance to a lead vehicle, etc.

In some embodiments, the threshold values may be used to filter out “noise” from the sensors 202 or third parties. For example, when the confidence interval for a particular environmental condition is below the threshold value, the behavior rule set 507 may disregard the environmental condition. In some embodiments, the behavior and planning module 238 may implement different rule sets of the behavior rule sets 507, depending on whether the confidence interval of a particular environmental condition is above or below one or more threshold values. For example, the behavior and planning module 238 may be operating under a first rule set of the behavior rule sets 507, and when the confidence interval that it is snowing reaches a threshold value, the behavior and planning module 238 will implement a second rule set of the behavior rule sets 507.

In some embodiments, the confidence interval of a given environmental condition, or a combination of environmental conditions, may be compared against different threshold values, each defining different actions to be taken. For example, the confidence interval associated with the presence of ice on an uphill road may be compared against a first threshold value. If the confidence interval is above the first threshold value, the behavior and planning module 238 may reduce the speed of the autonomous vehicle 100 and increase the following distance D to the lead vehicle 401. The confidence interval may then be compared against a second threshold value. If the confidence interval is above the second threshold value, the behavior and planning module 238 may downshift the autonomous vehicle 100 to a lower gear and further increase the following distance D to the lead vehicle 401. In this way, adjustments in the behavior of the autonomous vehicle 100 are performed in a stepwise fashion. In some embodiments, the confidence interval may further be compared against a different threshold value defining different behavior changes to the operation of the autonomous vehicle 100. For example, when the confidence interval that there is snow on the road exceeds a threshold value a snow plow may be deployed.

Once the behavior changes to the operation of the autonomous vehicle are determined by the behavior rule sets 507, a trajectory planning submodule 509 determines how to implement the behavior changes. For example, if the behavior rule sets 507 determine that the velocity of the autonomous vehicle 100 should be reduced or the target distance to the lead vehicle should be increased, it may be dangerous for the autonomous vehicle to suddenly apply the brakes to achieve the desired velocity and target distance. The trajectory planning submodule 509 will determine how and the order the actuators 503 will be activated to implement the desired behavior changes. In some embodiments, the trajectory planning submodule 509 may act as an override to the determined behavior changes to prevent unintended or adverse behavior changes. For example, if the conditions to deploy a snow plow on the autonomous vehicle 100 have been met but the autonomous vehicle 100 is moving too fast to safely lower the snow plow, the trajectory planning submodule 509 will override the behavior change to lower the snow plow until it is safe to do so.

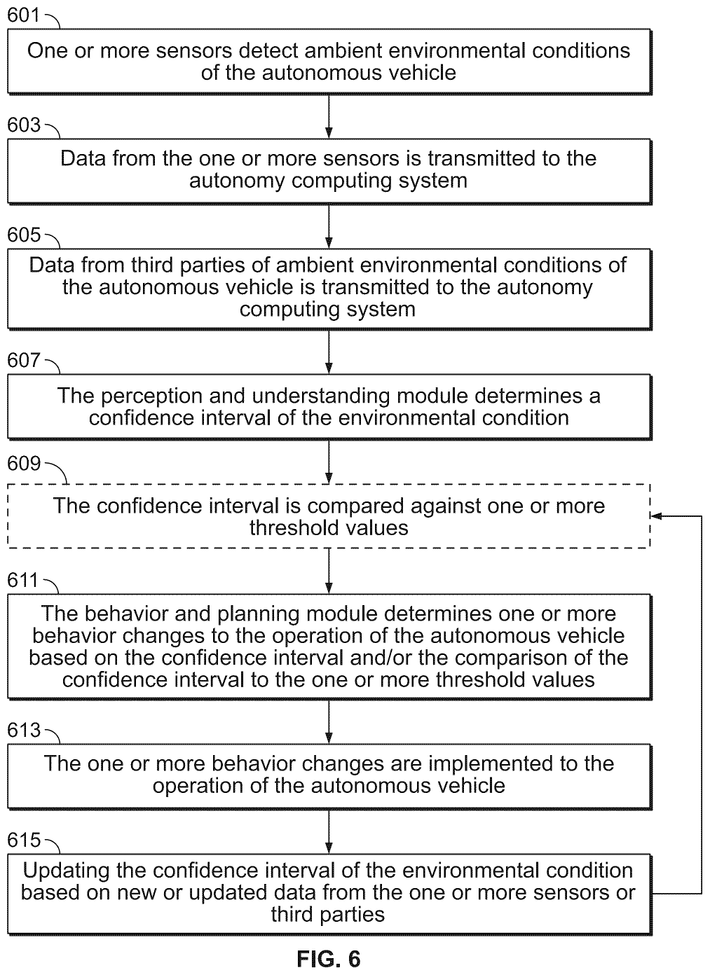

Referring now to FIG. 6, shown is a flow chart depicting a method of operating the autonomous vehicle 100 in adverse conditions according to some embodiments of the present disclosure. At 601 one or more of the sensors 202 detect ambient environmental conditions of the autonomous vehicle 100, including weather conditions and the conditions of the road. At 603 the data from the sensors is transmitted to the autonomy computing system 200 and at 605 data from third parties about the ambient environmental conditions is transmitted to the autonomy computing system 200.

At 607 the perception and understanding module 236 determines a confidence interval of each of the ambient environmental conditions. The confidence interval being representative of the perception and understanding module's 236 confidence that the perceived environmental conditions actually exists. In some embodiments, the method bypasses 605 and the confidence interval is based on the data from the sensors 202. At 609 the confidence interval is compared against one or more threshold values, the threshold values defining different behavior changes to the operation of the autonomous vehicle 100. In some embodiments, method portion 609 is optional and may be bypassed.

At 611 the behavior and planning module 238 determines one or more behavior changes to the operation of the autonomous vehicle 100 based on the comparison of the confidence interval to the one or more threshold values. At 613 the one or more behavior changes to the operation of the autonomous vehicle 100 are implemented, for example, by actuators 503 or by the controller 240.

At 615 the confidence interval of the ambient environmental conditions is updated in response to new or updated data from the sensors 202 or the third parties. The new or updated data may be transmitted continuously in real time or at set intervals. Then, at 609, the updated confidence interval is compared against the one or more threshold values to determine if the one or more behavior changes should be updated based on the updated confidence interval.

In some embodiments, the operation of the autonomous vehicle 100 in adverse conditions may be implemented as follows. The autonomous vehicle 100 is driving behind a lead vehicle 401. The perception and understanding module 236 receives the following input data: the temperature sensor 218 detects that the surface of the road is 2° C. (35.6° F.); a local weather station reports the ambient temperature is 3° C. (37.4° F.), and there are flurries, and has issued an icy road warning for the area; other vehicles in the fleet in a 20 mile radius have reported icy road conditions; the local department of transportation reports the road the autonomous vehicle 100 is driving on has a 5% incline; and the cameras 214 detect streaks in the image data indicating snow is falling and that the road surface is reflective, indicating the road is wet or icy. Based on the input data, the perception and understanding module 236 determines a confidence interval or likelihood that the road is wet, that the road is icy, and that the road has packed snow. These confidence intervals and the road grade are transmitted to the behavior and planning module 238, whereby one or more of the behavior rule sets 507 determine what behavior changes, if any, should be implemented to the velocity, target distance to the lead vehicle, and momentum of the autonomous vehicle 100. The trajectory planning submodule 509 then determines how to implement the desired behavior changes, and the behavior changes are implemented via the actuators 503.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory comprises non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A method for operation of an autonomous vehicle in adverse environmental conditions, the autonomous vehicle comprising at least one sensor, the method comprising:
using the at least one sensor to develop a first data set indicative of at least one environmental condition;
transmitting the first data set to a computing system for controlling an operation of the autonomous vehicle;
determining a confidence interval associated with each of the at least one environmental condition based on the first data set from the one or more sensors;
determining one or more behavior changes to the operation of the autonomous vehicle required based on the confidence interval; and
implementing the one or more behavior changes to the operation of the autonomous vehicle.

2. The method of claim 1, further comprising transmitting a second data set indicative of one or more of the at least one environmental conditions from at least one third party to the computing system;
wherein determining the confidence interval of each of the at least one environmental conditions if further based on the second data set from the at least one third party.

3. The method of claim 2, wherein one or more of the at least one third party comprises a weather service, a fleet commander, or a government agency.

4. The method of claim 1, wherein the one or more behavior changes comprises at least one of:
varying a speed of the autonomous vehicle;
varying a momentum of the autonomous vehicle;
varying a following distance to a lead vehicle of the autonomous vehicle;
varying a transmission gear of the autonomous vehicle; and
varying a position of the autonomous vehicle relative to one or more features on a road.

5. The method of claim 4, wherein the one or more features on the road are tire tracks.

6. The method of claim 1, further comprising comparing the confidence interval of each of the at least one environmental conditions to a first threshold value when determining the one or more behavior changes to the operation of the autonomous vehicle.

7. The method of claim 6, further comprising comparing the confidence interval of each of the at least one environmental conditions to a second threshold value when determining the one or more behavior changes to the operation of the autonomous vehicle.

8. The method of claim 1, further comprising transmitting an update the first data from the one or more sensors.

9. The method of claim 8, further comprising updating the confidence interval of each of the at least one environmental conditions based on the update to the first data from the one or more sensors.

10. The method of claim 9, further comprising updating the one or more behavior changes to the operation of the autonomous vehicle based on the update to the confidence interval of each of the at least one environmental conditions.

11. The method of claim 1, wherein the at least one environmental conditions is associated with the one or more behavior changes.

12. The method of claim 11, further comprising:
storing the one or more behavior changes to the operation of the autonomous vehicle on a database of behavior changes;
comparing the one or more behavior changes to at least one other behavior change stored on the database associated with the same at least one environmental conditions;
updating the one or more behavior changes to the operation of the autonomous vehicle based on the comparison of the one or more behavior changes to at least one other behavior change stored on the database.

13. The method of claim 1, wherein the one or more sensors are mounted on the autonomous vehicle.

14. A method for operation of an autonomous vehicle in adverse environmental conditions comprising:
transmitting a first data indicative of at least one environmental conditions to a computing system controlling an operation of the autonomous vehicle;
transmitting a second data indicative of the at least one environmental conditions from at least one third party to the computing system;
determining a confidence interval of each of the at least one environmental conditions based on the first data and the second data;
determining one or more behavior changes to the operation of the autonomous vehicle based on the confidence interval; and
implementing the one or more behavior changes to the operation of the autonomous vehicle.

15. The method of claim 14, further comprising comparing the confidence interval of each of the at least one environmental conditions to a first threshold value when determining the one or more behavior changes to the operation of the autonomous vehicle.

16. The method of claim 15, further comprising comparing the confidence interval of each of the at least one environmental conditions to a second threshold value when determining the one or more behavior changes to the operation of the autonomous vehicle.

17. A method for operation of a fleet of autonomous vehicles in adverse weather conditions comprising:
detecting an ambient environmental condition of each autonomous vehicle in the fleet of autonomous vehicles;
storing the ambient environmental condition of each autonomous vehicle on a database;
transmitting the ambient environmental condition of at least one other autonomous vehicle to a first computing system controlling an operation of a first autonomous vehicle in the fleet of autonomous vehicles;
determining a first confidence interval of the ambient environmental condition of the first autonomous vehicle based on the ambient environmental condition of the at least one other autonomous vehicle;
determining one or more first behavior changes to the operation of the first autonomous vehicle based on the confidence interval; and
implementing the one or more behavior changes to the operation of the first autonomous vehicle.

18. The method of claim 17, further comprising:
transmitting the ambient environmental condition of the at least one other autonomous vehicle to a second computing system controlling a second operation of a second autonomous vehicle in the fleet of autonomous vehicles;
determining a second confidence interval of the ambient environmental condition of the second autonomous vehicle based on the ambient environmental condition of the at least one other autonomous vehicle;
determining one or more second behavior changes to an operation of the second autonomous vehicle based on the second confidence interval and the one or more first behavior changes to the operation of the first autonomous vehicle; and
implementing the one or more second behavior changes to the operation of the second autonomous vehicle.

19. The method of claim 18, further comprising:
comparing the first confidence interval of the ambient environmental condition to a first threshold value when determining the one or more first behavior changes to the operation of the first autonomous vehicle; and
comparing the second confidence interval of the ambient environmental condition to the first threshold value when determining the one or more second behavior changes to the operation of the second autonomous vehicle.

20. The method of claim 19, further comprising:
comparing the first confidence interval of the ambient environmental condition to a second threshold value when determining the one or more first behavior changes to the operation of the first autonomous vehicle; and
comparing the second confidence interval of the ambient environmental condition to the second threshold value when determining the one or more second behavior changes to the operation of the second autonomous vehicle.
